(19) United States
(12) Patent Application Publication
(10) Pub. No.: US 2009/0239012 A1
(43) Pub. Date: Sep. 24, 2009

(54) PREFORM FOR A CONTAINER PRODUCED BY STRETCH-BLOW MOULDING

(76) Inventors: Jacques Thomasset, Vouvry (CH); Hugues-Vincent Roy, Vouvry (CH); Joachim Pellissier, Vouvry (CH)

Correspondence Address: NIXON & VANDERHYE, PC, 901 NORTH GLEBE ROAD, 11TH FLOOR, ARLINGTON, VA, 22203, US

(21) Appl. No.: 12/303,823

(22) PCT Filed: Jul. 9, 2007
(86) PCT No.: PCT/IB2007/052686

§ 371 Date: Jan. 16, 2009

(30) Foreign Application Priority Data
Jul. 20, 2006 (EP) 06117557.6

(51) Int. Cl. B29C 49/02; B29C 49/22; B32B 1/08

(52) U.S. Cl. 428/35.7; 428/542.8; 264/531

(57) ABSTRACT

The invention relates to a preform (1) for making a package by blow-moulding comprising three separate components joined to one another, namely a side wall (3), a base (4), and an upper part (2) comprising an opening, characterized in that the thickness of the side wall (3) is smaller than the thickness of the base (4). The invention also relates to a package obtained by blow-moulding said preform (1).

### FIELD OF THE INVENTION

The present invention lies in the field of plastic containers produced by blow-moulding a preform in a mould. The invention relates to a preform and its embodiment for producing containers by stretch-blow moulding in a mould. It also relates to the packages obtained by blow-moulding such preforms. The invention makes it possible to use a wide variety of resins and makes it possible to obtain very thin-walled containers.

The present invention is intended particularly, but not exclusively, for the following uses:
packaging of beverages such as fruit juice, vitamin drinks, milk, iced tea, etc.;
packaging of viscous products such as toothpaste, body care creams, pharmaceutical ointments, food products (mayonnaise, ketchup, mustard), etc.;
packaging of technical products such as silicone or mastic.

### PRIOR ART

In the industry of plastic packaging produced by blow-moulding a preform, it is conventional to injection-mould a preform, said preform comprising a neck, a side wall and a base. This preform has many advantages: it may be single-layer or multilayer, it may be manufactured at high rates in a multi-impression mould, and it allows a wide variety of packaging geometry.

The container obtained by blow-moulding said preform comprises three separate parts, namely an upper part comprising a neck, a base on which the container rests, and side walls connecting the neck to the base. The neck allows the opening/closing function of the container while guaranteeing leaktightness. The neck generally contains means for handling the preform or the blow-moulded container, said means being used during blow-moulding of the preform, and also during filling of the container. The various functions of the neck, such as leaktightness and opening/closing, require great accuracy in its geometry.

Japanese Patent Application JP 62-051423A describes preforms that may be composed of at least two separate parts, e.g. a base and a side wall or an upper part and a side wall.

The moulding techniques, in particular those described in the aforementioned prior art, make it impossible simultaneously to obtain side walls having a small thickness and the aforementioned properties at the neck. This difficulty is linked, in particular, to the limits of the injection-moulding process and to the difficulty of moulding side walls having a small thickness while obtaining great accuracy at the neck. It is also linked to the fact that, to date, it has systematically been sought to obtain a base and a side wall of the same thickness. During the process of manufacturing preforms exclusively using injection moulding, the thermoplastic resin injected into the mould cavity progressively fills the base, then the side walls and finally flows into the neck. It is difficult to obtain a very accurate neck if the thickness of the side wall is less than that of the neck, since the injected resin is cooled more rapidly in the side walls and prevents sufficient filling of the neck. It is therefore clearly apparent that there are limits as regards the thickness of the side walls, and the latter may not be much smaller than those of the neck.

Patent Application WO 2005/066027 proposes to solve the aforementioned problem thanks to a preform formed by joining two parts, the first part being the neck and the second part being the cavity formed by the side wall and the base. According to Patent Application WO 2005/066027, the two parts of the preforms are manufactured independently by injection moulding. One advantage of the aforementioned application lies in the possibility of producing packages that are thin-walled and that are filled at high temperature. The production of a preform having a side wall of small thickness makes it possible to prevent severe shrinkage and deformation of the package during hot-filling.

Patent Application WO 2005/066027 makes a wider variety of blow-moulded containers possible by manufacturing the preform in two parts; however, this patent application does not solve the problems associated with the base of the container. A person skilled in the art knows that the base of the container is often the most fragile part of the package. This fragility is displayed by the base cracking when the container is dropped and by the low strength of this part of the container during combined action of physical and chemical stresses (stress cracking).

Due to the geometry of current preforms, it is not possible to produce containers by blow-moulding with a wide variety of resins such as polyolefins (PE, PP), polyamides (PA-6), barrier resins (EVOH, PA-MXD6, PVDC). The prior art makes it impossible to produce blow-moulded containers comprising more than three resins in a multilayer structure. Both for technical and economic reasons, it may be advantageous to have a higher number of layers in the package.

### GENERAL SUMMARY OF THE INVENTION

The invention makes it possible to solve the aforementioned problems; in particular it makes it possible to obtain, by blow-moulding a preform, containers having ultra-thin side walls with a wide variety of resins while keeping a relatively thick base. The invention makes it possible to obtain packaging having small thickness with a large number of layers, and enables a large combination of multilayer structures.

The invention consists in producing a preform made from at least three parts, the first part forming the neck, the second part forming the side wall and the last part forming the base, the three parts being joined in order to form said preform. The preform according to the invention is characterized in that the thickness of the side wall is smaller than the thickness of the base and the thickness of the upper part.

One embodiment of the invention consists in using a preform having a design, said design generally being printed on the surface or in the thickness of the wall of the preform. Generally, only the second part of said preform forming the side wall has a print design.

### DETAILED SUMMARY OF THE INVENTION

The invention is described in further detail hereinafter by means of examples illustrated by the following figures:

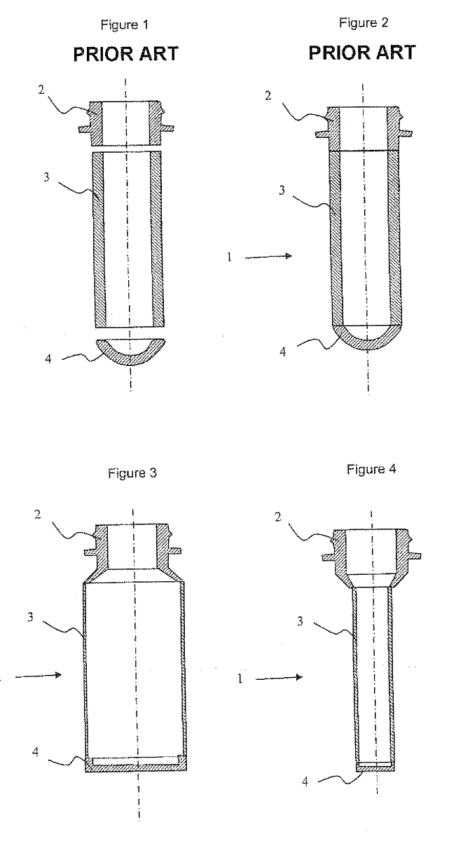

FIGS. 1 and 2 illustrate a three-part preform according to the prior art (JP 62-051423A).

FIGS. 3 and 4 show geometries of preforms corresponding to the invention.

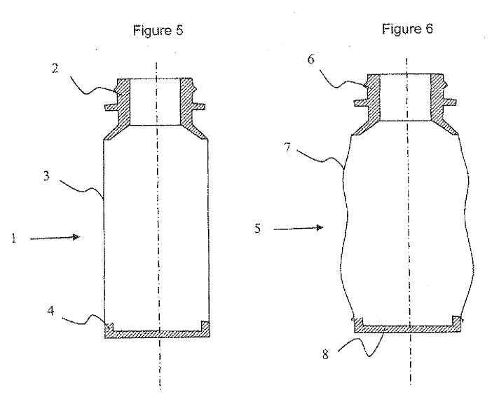

FIGS. 5 and 6 correspond to a preferred embodiment of the invention. FIG. 5 shows the preform corresponding to the preferred embodiment, and FIG. 6 illustrates the container obtained after blow-moulding.

FIG. 1 illustrates the production of a preform from the prior art made of several parts; namely a neck 2, side walls 3, and a base 4. The neck 2 is generally injection-moulded or compression-moulded in order to obtain great accuracy for this part of the preform. The side walls 3 may be injection-moulded or compression-moulded, or extruded in tubular form, or else shaped from a welded sheet. The base 4 may be moulded by injection-moulding or compression-moulding or manufactured by thermoforming.

FIG. 2 shows the preform 1 from FIG. 1 obtained by joining the neck 2, side walls 3 and base 4. The joining may be carried out by welding, by mechanical fitting of the various parts or by bonding.

FIG. 3 shows a preform geometry according to the invention obtained by joining. This preform comprises a neck 2, a side wall 3 and a base 4. The inside diameter of the side wall 3 is greater than the diameter of the neck 2, which makes this preform impossible to produce by moulding, by injection-moulding or by compression-moulding.

FIG. 4 illustrates another preform geometry having a side wall 3 of small thickness relative to the neck 2.

FIGS. 3 and 4 illustrate a great advantage of the invention that makes it possible to produce preforms having side walls of small thickness relative to the neck or to the base. These thin-walled preforms make it possible to obtain blow-moulded packages with advantageous properties.

The invention is particularly advantageous for producing ultra-thin-walled containers.

The invention is particularly advantageous for producing blow-moulded containers having high barrier properties, said containers allowing the preservation of sensitive products.

The invention is particularly advantageous for producing containers which may be filled at high temperature, said filling temperature being above 80° C.

FIGS. 5 and 6 illustrate another preferred embodiment of the invention. The preform corresponding to the preferred embodiment is illustrated in FIG. 5. This preform 1 comprises a neck 2, a base 4 and a side wall 3 of small thickness connected to the base and to the neck. The side walls 3 of the preform have a thickness of less than 400 microns and are manufactured by extrusion. The side wall 3 is welded to the base and the neck 2.

The invention makes it possible to produce containers having a side wall with a thickness smaller than 0.3 mm and having a stretch ratio of less than 5. In the case of a side wall obtained by welding a film to itself, the radial stretch ratio is generally less than 2. One example of this thin-walled container is illustrated in FIG. 6. This container may be single-layered or multilayered. It may be produced with a wide variety of resins. By way of example, this package may contain polyester resins (PET, PEN), polyolefins (PE, PP), polyamide resins, resins that enable the barrier properties to be improved (EVOH, PVDC, PA-MXD6). This container may also contain metallic layers such as for example a layer of aluminium.

The invention makes it possible to produce a container of which the thickness of the side wails is less than 0.2 mm. The preform makes it possible to obtain this container having side walls whose thickness is less than 0.4 mm.

The invention especially offers the advantage of producing blow-moulded packages which do not have an axis of symmetry. The invention makes it possible, for example, to produce containers having a square cross section from preforms having a square cross section. Similarly, containers having an oval cross section may be produced from a preform having an oval cross section.

Another advantage of the invention is the integration of function into the neck or the base. For example, the invention makes it possible to manufacture a preform comprising a neck with a lid, the neck and the lid being connected by a hinge and only forming a single part.

One particularly advantageous embodiment of the invention consists in giving the preform a printed design. During blow-moulding of the preform, the design deforms together with the wall, and the final design is obtained on the blow-moulded package. The design printed on the preform takes into account the deformation of the design during blow-moulding.

The method of manufacturing the preforms consists in separately manufacturing the three parts of said preform, namely the neck, the base and the side walls. These three parts are joined. According to one preferred embodiment of the invention, these parts are joined by welding, each of the parts comprising, at least at the site of joining, a layer at the surface that enables the joining by welding. The parts may also be joined by mechanical action (screwing, snap-fastening, fitting, etc.).

For joining parts by welding, it is advantageous to use a neck and a base made of PE or PP, said neck and said base being welded onto the side walls that comprise at least one layer made of PE or PP on the inner surface. The neck and the base are advantageously injection-moulded or compression-moulded. The side walls are extruded. It is advantageous to produce the side walls from a film welded to itself in order to form a cylindrical body. The film forming said cylindrical body generally comprises several layers. One particularly advantageous embodiment of the invention consists in using a printed film to form the cylindrical body. Said film may be flat-printed, which makes it possible to produce high quality design at reduced costs. When the film comprises several layers, the design may be located on the surface of said film or in the thickness of said film at the interface between two layers. Starting from a printed multilayer film, one embodiment of the invention therefore makes it possible to obtain a preform the design of which is located on the surface or is trapped within the thickness of its side wall.

The method of blow-mouiding the preform consists in deforming only the side walls, the base and the neck not being deformed. The joins between the various parts of the preform are also protected during the blow-moulding so that these joins are not deformed.

The method of blow-moulding consists in heating the side walls of said preform and in forming the package by stretch-blow moulding of said preform in a mould.

The method of blow-moulding preforms according to the preferred embodiment of the invention optionally comprises a phase of heating the preforms, said heating phase being strongly reduced considering the small thickness of the side walls of the preform. Only the side walls of the preform are heated; the joins between the side walls and the neck and the base are not heated. The preforms are then blow-moulded in a mould; only the side walls of said preform deform during the blow-moulding. The method of blow-moulding the preform according to the preferred embodiment of the invention consists in not stretching said preform in the mould so that the height of the container produced is equivalent to the height of the preform. The side walls of said preform are therefore deformed only radially. It has been found that it is advantageous to blow-mould these preforms with a deformation ratio of less than 2. It has also been found that, due to the reduced thickness of the side walls of said preform, it is possible in certain cases not to heat the side walls of the preform before blow-moulding. Blow-moulding a preform with a deformation ratio of less than 2 and at room temperature is particularly advantageous when the preform is printed. It is observed that when the side wall of the preform comprises an aluminium layer in its thickness, the blow-moulding of the preform without prior heating is facilitated. When a heating operation is required for blow-moulding the printed preform, the use of hot air is generally preferable to radiant heating.

1. Preform (1) for making a package by blow-moulding comprising three separate components joined to one another, namely a side wall (3), a base (4), and an upper part (2) comprising an opening, characterized in that the thickness of the side wall (3) is smaller than the thickness of the base (4) and smaller than the thickness of the upper part (2).

2. Preform (1) according to claim 1, in which the side wall (3) is flexible.

3. Preform (1) according to claim 2, in which the side wall (3) has a thickness of less than 400 microns.

4. Preform (1) according to claim 2, in which the side wall (3) is composed of a laminate.

5. Preform (1) according to claim 2, in which the side wall (3) is formed by extrusion.

6. Preform (1) according to claim 1, in which the base (4) and the upper part (2) are injection-moulded or compression-moulded.

7. Preform (1) according to claim 1, of which at least two components are joined by welding.

8. Preform (1) according to claim 1, of which at least two components are joined by snap-fastening.

9. Preform (1) according to claim 1, of which the thickness of the upper part (2) is two times greater than the thickness of the side wall (3).

10. Preform (1) according to claim 1, of which the side wall (3) is multilayered.

11. Preform (1) according to claim 1, of which the inside diameter of the opening is less than the inside diameter of the side wall (3).

12. Preform (1) according to claim 1, of which the side wall (3) is cylindrical.

13. Preform (1) according to claim 1, of which the side wall (3) has an oval cross section.

14. Preform (1) according to claim 1, of which the side wall (3) has a polygonal cross section.

15. Preform (1) according to claim 1, of which the side wall (3) comprises a printed design.

16. Method of blow-moulding a preform (1) comprising at least three separate components welded to one another, namely a side wall (3), a base (4) and an upper part (2) comprising an opening; method consisting in deforming said preform by blow-moulding in the cavity of a mould; method characterized in that only the side wall (3) is deformed by blow-moulding, in that the axial stretch ratio of the preform is less than 1.1 and in that the radial stretch ratio of the preform is less than 5.

17. Method according to claim 16, consisting in not deforming the side wall (3) at the join with the base and the upper part.

18. Method according to claim 16, consisting in blow-moulding said preform (1) at ambient temperature in the mould cavity.

19. Method according to claim 16, consisting in heating only the side wall (3) of said preform (1) before blow-moulding.

20. Method according to claim 16, consisting in axially blocking the base (4) and the upper part (2) during the blow-moulding in order to prevent an elongation of said preform (1).

21. Package obtained by blow-moulding a preform (1) according to claim 1, characterized in that its side wall (3) comprises at least two cylindrical parts, a first one being located at the join between the side wall (3) and the base (4) and the second one being located at the join between the side wall (3) and the upper part (2); in that the diameter of said cylindrical parts is identical; and in that the ratio between the maximum diameter and the diameter at the joins is less than 5.
